(19) United States
(12) Patent Application Publication
(10) Pub. No.: US 2006/0030501 A1
(43) Pub. Date: Feb. 9, 2006

(54) Personal cleansing composition containing wax particles and platelet, spherical, or irregularly shaped particles

(76) Inventor: Michael Frederick Niebauer, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/197,894

(22) Filed: Aug. 5, 2005

Related U.S. Application Data
(60) Provisional application No. 60/599,375, filed on Aug. 6, 2004.

(51) Int. Cl. C11D 17/00

(52) U.S. Cl. 510/127

(57) ABSTRACT

Personal cleansing compositions comprise (a) from about 5 wt. % to about 50 wt. % of a detersive surfactant, (b) from about 0.05 wt. % to about 20 wt. % of a first particle which is a wax particle having a melting point of at least about 90° C. and an average mean particle size as measured in said personal cleansing composition from about 0.15 μm to about 100 μm; (c) from about 0.05 wt. % to about 20 wt. % of a second particle which is selected from platelet particles, irregularly shaped particles, and mixtures thereof, the second particle having an average particle size as measured in said personal cleansing composition from about 0.15 μm to about 300 μm; and (d) at least about 20 wt. % of a cosmetically acceptable medium; wherein the first particle and the second particle together form a load-sensitive deposit upon dilution of said personal cleansing composition with water. Methods of providing both increased volume and superior styling and conditioning to hair comprise applying the personal care composition as described above to the hair and rinsing the hair.

### CROSS REFERENCE TO RELATED APPLICATIONS

This application claims the benefit of U.S. Provisional application Ser. No. 60/599,375 (Case 9737P), filed on Aug. 6, 2004.

### FIELD OF THE INVENTION

The present invention relates to personal cleansing compositions containing particles. More specifically, it relates to personal cleansing compositions containing a first particle which is a wax particle and a second particle which is a platelet particle, a spherical particle, an irregularly shaped particle, or a mixture thereof. The compositions are intended to deliver the benefits of hair volume and fullness, as well as improved conditioning and combing.

### BACKGROUND OF THE INVENTION

Solid particles are known for use as benefit agents in a variety of formulations and personal care compositions. Solid particles can impart benefits both to the compositions comprising them or surfaces to which the compositions are applied. For examples, solid particles can be used as pigments or coloring agents, opacifiers, pearlescent agents, feel modifiers, oil absorbers, skin protectants, matting agents, friction enhancers, slip agents, conditioning agents, exfoliants, odor absorbers, or cleaning enhancers. Additionally, many active ingredients useful as treatment agents for various disorders or socially embarrassing conditions are available and typically used in solid particulate form including antiperspirant agents, anti-dandruff agents, antimicrobials, antibiotics, and sunscreens.

Typically when it is desired to modify the properties of a surface through application of particles, the particles are applied via leave-on preparations that are rubbed, sprayed, or otherwise applied directly onto the surface to be affected. Typical personal care preparations suitable for delivery of solid particles to hair or skin surfaces include moisturizers, lotions, creams, loose or pressed powders, sticks, tonics, gels, and various sprays such as aerosol or pump sprays. These products are typically applied directly to the surface whereupon particles are deposited and retained by the composition itself or by residual non-volatile elements of the composition after evaporation and drying.

It is also known to formulate solid particle benefit agents into rinse-off or cleansing compositions such as hair rinses, shampoos, liquid and bar soaps, conditioners, or colorants. Frequently, the solid particle benefit agent is used to affect the overall appearance, stability or aesthetics of the composition itself. For example, it is known to add colorant particles, pigments, or pearlescent agents to compositions to improve the acceptability and attractiveness of the product to potential consumers. It is also known to add particulate benefit agents to affect the in use performance, appearance or aesthetic properties of the composition or to provide a tactile signal to the user. For example, exfoliant particles are frequently used in cleansing compositions to improve abrasion and removal of oils and dirt from washed surfaces and to impart a perceptible “scrubbing” sensation to the user. Typically, such solid particle agents are not intended or desired to be deposited onto the substrate and are removed during dilution and rinsing of the composition from the surface to which they are applied.

It is also known to formulate solid particles into rinse-off or cleansing compositions to improve the volume, body, or fullness of the hair through increased interactions between hair fibers. When deposition of solid particle benefit agents from washing compositions is intended, the compositions available heretofore have suffered from the drawbacks of inefficient deposition, requiring the use of excess amounts of the particle agent or ineffective benefit delivery. Further, compositions containing solid particles intended to provide increased interaction between hair fibers frequently result in negative conditioning, wet detangling, and wet combing performance due to the frictional impact of the particles. Therefore, the negative conditioning and combing effects associated with the deposition of particles often outweigh the positive hair volume and body results. Prior attempts to mitigate the negative conditioning attributes of particle containing compositions have either been insufficient or have negatively impacted the deposition or benefit associated with the particle.

Accordingly, a need still exists for a rinse-off cleansing composition which is capable of containing and effectively depositing and retaining particle benefit agents on the treated surface to deliver improved hair volume, body, and fullness, while simultaneously delivering improved conditioning and combing performance.

### SUMMARY OF THE INVENTION

It has now been discovered that co-deposits on the hair of wax particles and platelet and/or spherical and/or irregularly shaped particles act synergistically to provide a load-sensitive deposit wherein, at very low force applied to the hair, the particles act to increase hair friction which prevents hairs from moving past each other, and, at higher force applied to the hair, the hair friction is reduced to provide improved conditioning and combing performance relative to that of clean hair.

The present invention is directed to a personal cleansing composition comprising:
a) from about 5 wt. % to about 50 wt. % of a detersive surfactant,
b) from about 0.05 wt. % to about 20 wt. % of a first particle which is a wax particle having a melting point of at least about 90° C. and an average mean particle size as measured in said personal cleansing composition from about 0.15 μm to about 100 μm;
c) from about 0.05 wt. % to about 20 wt. % of a second particle which is selected from the group consisting of platelet particles, spherical particles, irregularly shaped particles, and mixtures thereof, said second particle having an average mean particle size as measured in said personal cleansing composition from about 0.15 μm to about 300 μm; and
d) at least about 20 wt. % of a cosmetically acceptable medium;
wherein said first particle and said second particle together form a load-sensitive deposit upon dilution of said personal cleansing composition with water.

The present invention is further directed to a method of using the personal cleansing composition.

These and other features, aspects, and advantages of the present invention will become evident to those skilled in the art from a reading of the present disclosure.

### DETAILED DESCRIPTION

While the specification concludes with claims that particularly point out and distinctly claim the invention, it is believed the present invention will be better understood from the following description.

The personal cleansing compositions of the present invention comprise detersive surfactant; a first particle which is a wax particle; a second particle which is selected from platelet particles, spherical particles, irregularly shaped particles, and mixtures thereof; and a cosmetically acceptable medium. Each of these essential components, as well as preferred or optional components, is described in detail hereinafter.

All percentages, parts and ratios are based upon the total weight of the compositions of the present invention, unless otherwise specified. All such weights as they pertain to listed ingredients are based on the active level and, therefore, do not include solvents or by-products that may be included in commercially available materials, unless otherwise specified. The term “weight percent” may be denoted as “wt. %” herein.

All molecular weights as used herein are weight average molecular weights expressed as grams/mole, unless otherwise specified.

Herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

The term “load-sensitive deposit” as used herein refers to a material which, at very low force applied to the hair (e.g., the normal force present with hair-to-hair contact), acts to increase hair friction relative to the hair friction of clean hair, and, at higher force applied to the hair (e.g., the force present during combing), acts to decrease hair friction relative to the hair friction at very low force.

The “aspect ratio” refers to the ratio of the largest dimension of the particle to the smallest dimension of the particle.

The term “platelet” as used herein means a particle having an aspect ratio of greater than about 10.

The term “spherical” as used herein means a particle having a physical shape which comprises the set of points in a metric space whose distance from a fixed point is approximately constant. Here, the meaning of “approximately” is that the fixed points are within a distance of ±15%.

The term “non-platelet” as used herein means a particle having a spherical, an oval, an irregular, or any other shape in which the ratio of the largest dimension to the smallest dimension (defined as the aspect ratio) is less than about 10.

The term “irregular” as used herein, means a non-spherical and non-platelet particle having an aspherical, oval, elliptical, or other non-uniform shape and/or a non-uniform surface texture.

The term “hollow” as used herein, means a particle having an encapsulated area that is substantially free of solid mass, the encapsulated area comprising from 10 to 99.8 percent of the total volume of the particle.

The term “polymer” as used herein includes materials whether made by polymerization of one type of monomer or made by two (i.e., copolymers) or more types of monomers.

The term “water-soluble” as used herein means that a substance is soluble in water in the present composition. In general, the substance should be soluble at 25° C. at a concentration of at least about 0.1% by weight of the water solvent, preferably at least about 1%, more preferably at least about 5%, even more preferably at least about 15%.

The term “particle size” as used herein refers to the average mean particle size of a group of particles as seen in a composition of the present invention using a Zeiss Akzioskop at 400× magnification.

Viscosity measurements are achieved using a Brookfield R/S Rheometer at a shear rate of 2 s⁻¹ for 3 minutes.

A. Detersive Surfactant

The compositions of the present invention comprise a detersive surfactant. The detersive surfactant component is included to provide cleaning performance to the composition. The detersive surfactant component in turn comprises anionic detersive surfactant, zwitterionic or amphoteric detersive surfactant, or a combination thereof. Such surfactants should be physically and chemically compatible with the essential components described herein, or should not otherwise unduly impair product stability, aesthetics or performance.

Suitable anionic detersive surfactant components for use in the composition herein include those which are known for use in hair care or other personal care cleansing compositions. The concentration of the anionic surfactant component in the composition should be sufficient to provide the desired cleaning and lather performance, and generally range from about 5% to about 50%, preferably from about 8% to about 30%, more preferably from about 10% to about 25%, even more preferably from about 12% to about 22%.

Preferred anionic surfactants suitable for use in the compositions are the alkyl and alkyl ether sulfates. These materials have the respective formulae ROSO₃M and RO(C₂H₄O)ₓSO₃M, wherein R is alkyl or alkenyl of from about 8 to about 18 carbon atoms, x is an integer having a value of from 1 to 10, and M is a cation such as ammonium, alkanolamines, such as triethanolamine, monovalent metals, such as sodium and potassium, and polyvalent metal cations, such as magnesium, and calcium.

Preferably, R has from about 8 to about 18 carbon atoms, more preferably from about 10 to about 16 carbon atoms, even more preferably from about 12 to about 14 carbon atoms, in both the alkyl and alkyl ether sulfates. The alkyl ether sulfates are typically made as condensation products of ethylene oxide and monohydric alcohols having from about 8 to about 24 carbon atoms. The alcohols can be synthetic or they can be derived from fats, e.g., coconut oil, palm kernel oil, tallow. Lauryl alcohol and straight chain alcohols derived from coconut oil or palm kernel oil are preferred. Such alcohols are reacted with from about 0 and about 10, preferably from about 2 to about 5, more preferably about 3, molar proportions of ethylene oxide, and the resulting mixture of molecular species having, for example, an average of 3 moles of ethylene oxide per mole of alcohol, is sulfated and neutralized.

Other suitable anionic detersive surfactants are the water-soluble salts of organic, sulfuric acid reaction products conforming to the formula R¹—SO₃-M wherein R¹ is a straight or branched chain, saturated, aliphatic hydrocarbon radical having from about 8 to about 24, preferably from about 10 to about 18, carbon atoms; and M is a cation described hereinbefore.

Still other suitable anionic detersive surfactants are the reaction products of fatty acids esterified with isethionic acid and neutralized with sodium hydroxide where, for example, the fatty acids are derived from coconut oil or palm kernel oil; sodium or potassium salts of fatty acid amides of methyl tauride in which the fatty acids, for example, are derived from coconut oil or palm kernel oil. Other similar anionic surfactants are described in U.S. Pat. Nos. 2,486,921; 2,486,922; and 2,396,278.

Other anionic detersive surfactants suitable for use in the compositions are the succinnates, examples of which include disodium N-octadecylsulfosuccinnate; disodium lauryl sulfosuccinate; diammonium lauryl sulfosuccinate; tetrasodium N-(1,2-dicarboxyethyl)-N-octadecylsulfosuccinnate; diamyl ester of sodium sulfosuccinic acid; dihexyl ester of sodium sulfosuccinic acid; and dioctyl esters of sodium sulfosuccinic acid.

Other suitable anionic detersive surfactants include olefin sulfonates having from about 10 to about 24 carbon atoms. In addition to the true alkene sulfonates and a proportion of hydroxy-alkanesulfonates, the olefin sulfonates can contain minor amounts of other materials, such as alkene disulfonates depending upon the reaction conditions, proportion of reactants, the nature of the starting olefins and impurities in the olefin stock and side reactions during the sulfonation process. A non-limiting example of such an alpha-olefin sulfonate mixture is described in U.S. Pat. No. 3,332,880.

Another class of anionic detersive surfactants suitable for use in the compositions is the beta-alkyloxy alkane sulfonates. These surfactants conform to the formula: 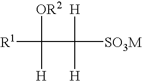
where R¹ is a straight chain alkyl group having from about 6 to about 20 carbon atoms, R² is a lower alkyl group having from about 1 to about 3 carbon atoms, preferably 1 carbon atom, and M is a water-soluble cation as described hereinbefore.

Preferred anionic detersive surfactants for use in the compositions include ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, triethanolamine lauryl sulfate, triethanolamine lauryl sulfate, monoethanolamine cocoyl sulfate, monoethanolamine lauryl sulfate, sodium tridecyl benzene sulfonate, sodium dodecyl benzene sulfonate, sodium cocoyl isethionate and combinations thereof.

Suitable zwitterionic or amphoteric detersive surfactants for use in the composition herein include those which are known for use in hair care or other personal cleansing compositions. Concentration of such amphoteric detersive surfactants preferably ranges from about 0.5% to about 20%, preferably from about 1% to about 10%. Non-limiting examples of suitable zwitterionic or amphoteric surfactants are described in U.S. Pat. Nos. 5,104,646 and 5,106,609, both to Bolich Jr. et al.

Amphoteric detersive surfactants suitable for use in the composition are well known in the art, and include those surfactants broadly described as derivatives of aliphatic secondary and tertiary amines in which the aliphatic radical can be straight or branched chain and wherein one of the aliphatic substituents contains from about 8 to about 18 carbon atoms and one contains an anionic group such as carboxy, sulfonate, sulfate, phosphate, or phosphonate. Preferred amphoteric detersive surfactants for use in the present invention include cocoamphoacetate, cocoamphodiacetate, lauroamphoacetate, lauroamphodiacetate, and mixtures thereof.

Zwitterionic detersive surfactants suitable for use in the composition are well known in the art, and include those surfactants broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group such as carboxy, sulfonate, sulfate, phosphate or phosphonate. Zwitterionics such as betaines are preferred.

The compositions of the present invention may further comprise additional surfactants for use in combination with the anionic detersive surfactant component described hereinbefore. Suitable optional surfactants include nonionic and cationic surfactants. Any such surfactant known in the art for use in hair or personal care products may be used, provided that the optional additional surfactant is also chemically and physically compatible with the essential components of the composition, or does not otherwise unduly impair product performance, aesthetics or stability. The concentration of the optional additional surfactants in the composition may vary with the cleansing or lather performance desired, the optional surfactant selected, the desired product concentration, the presence of other components in the composition, and other factors well known in the art.

Non-limiting examples of other anionic, zwitterionic, amphoteric or optional additional surfactants suitable for use in the compositions are described in McCutcheon's, Emulsifiers and Detergents, 1989 Annual, published by M. C. Publishing Co., and U.S. Pat. Nos. 3,929,678; 2,658,072; 2,438,091; and 2,528,378.

B. Load-Sensitive Deposit

The personal cleansing compositions of the present invention comprise a first particle which is a wax particle and a second particle which is selected from platelet particles, spherical particles, irregularly shaped particles, and mixtures thereof, wherein the first particle and the second particle together form a load-sensitive deposit upon dilution of the personal cleansing composition with water. As used herein, a “load-sensitive deposit” is a material which, at very low force applied to the hair, acts to increase hair friction relative to the hair friction of clean hair, and, at higher force applied to the hair, acts to decrease hair friction relative to the hair friction at very low force. In one embodiment of the present invention, the load-sensitive deposit forms upon dilution of the personal cleansing composition with water at a ratio of water to personal cleansing composition of at least about 1:1.

To deliver positive hair volume and body effects through the use of a deposit onto the hair, while still maintaining positive conditioning and combing performance, the deposit must perform differently under rest conditions and under combing conditions. Because the amount of force used to comb hair is magnitudes greater than the amount of force that hairs exert on other hairs when the hair is at rest, a deposit on the hair which provides a hair friction profile which changes as force applied to the hair changes can provide improved hair volume, body, and fullness, while maintaining a good conditioning and combing performance.

In compositions of the present invention, the friction profile can be controlled and altered through optimization of the particle ratios and selection of the appropriate wax particles and platelet and/or spherical and/or irregularly shaped particles.

In a preferred embodiment of the present invention, the ratio of first particles to second particles is equal to or greater than about 1:1.

1. First Particle—Wax Particles

The compositions of the present invention comprise a first particle which is a wax particle. The wax particles of the present invention have an average mean particle size from about 0.15 μm to about 100 μm, preferably from 0.15 μm to about 50 μm, more preferably from about 1 μm to about 30 μm.

The wax particle of the present invention has a melting point of at least about 90° C. Preferably, the wax particles have a melting point from about 90° C. to about 200° C., more preferably from about 90° C. to about 170° C., and even more preferably from about 90° C. to about 140° C. As used herein, the melting point refers to the temperature at which the particle transitions to a liquid or fluid state.

The compositions of the present invention comprise wax particles from about 0.05% to about 20%, preferably from about 0.1% to about 10%, more preferably from about 0.1% to about 5%, even more preferably about 0.1% to about 2%, by weight of the composition.

Wax particles suitable for use in compositions of the present invention include those which are generally known for use in hair care and other personal care compositions, such as those that are listed in the C.T.F.A. Cosmetic Ingredient Handbook, Sixth Ed., Cosmetic and Fragrance Assn., Inc., Washington D.C. (1995).

Non-limiting examples of suitable wax particles include polyethylenes, hydrocarbons, modified polyethylenes, oxidized polyethylenes, N,N′ Bisstearoylethylenediamine, polytetrafluroethylene, polytetrafluoroethylene modified polyethylenes, partily saponified esters, polypropylenes, amides, synthetic hydrocarbons and aliphatic compounds synthesized using the Fischer-Tropsch process, hydrocarbon waxes, and mixtures thereof.

Preferred wax particles of the present invention include polyethylenes, modified polyethylenes, oxidized polyethylenes, polytetrafluoroethylene modified polyethylenes, polypropylenes, synthetic hydrocarbons and aliphatic compounds synthesized using the Fischer-Tropsch process, hydrocarbon waxes, and mixtures thereof.

The wax particles of the present invention may be colored or non-colored (i.e., white or substantially clear).

In one embodiment of the present invention, the wax particle is a hydrocarbon wax particle having a particle size from about 1 μm to about 30 μm. Such hydrocarbon wax particles are available, for example, from Clariant Corp. under the trade name Ceridust.

In another embodiment of the present invention, the wax particle is a polyethylene, a modified polyethylene, or an oxidized polyethylene wax particle having a particle size from about 0.15 μm to about 30 μm. Such polyethylene, modified polyethylene, or oxidized polyethylene wax particles are available, for example, from Clariant Corp. under the trade name Ceridust, and from Micro Powders, Inc., under the trade name MPP.

2. Second Particle—Platelet, Spherical, and Irregularly Shaped Particles

The compositions of the present invention comprise a second particle which is selected from the group consisting of platelet particles, spherical particles, irregularly shaped particles, and mixtures thereof. The second particle of the present invention has an average mean particle size from about 0.15 μm to about 300 μm, preferably from about 0.15 μm to about 80 μm, more preferably from about 0.15 μm to about 60 μm, even more preferably from about 1 μm to about 40 μm.

The compositions of the present invention comprise from about 0.05% to about 20%, preferably from about 0.1% to about 10%, more preferably from about 0.1% to about 5%, even more preferably from about 0.1% to about 2%, by weight of the composition, of a second particle which is selected from the group consisting of platelet particles, spherical particles, irregularly shaped particles, and mixtures thereof.

Preferably, platelet particles, spherical particles, and irregularly shaped particles having melting points greater than about 70° C. are used. More preferably, such particles having a melting point greater than 80° C. are used, and, even more preferably, such particles having a melting point of greater than about 95° C. are used. As used herein, the melting point refers to the temperature at which the particle transitions to a liquid or fluid state. Some particles of present invention which are cross-linked or have a cross-linked surface membrane do not exhibit a distinct melting point. Such particles are useful provided that they are stable under the processing and storage conditions used in the making of the present compositions.

a. Platelet Particles

The platelet particles of the present invention are particles having an aspect ratio of greater than about 10. The “aspect ratio” is defined herein as the ratio of the largest dimension of the particle to the smallest dimension of the particle.

Platelet particles suitable for use in compositions of the present invention include those which are generally known for use in hair care and other personal care compositions, provided they are physically and chemically compatible with the essential components described herein, or do not otherwise unduly impair product stability, aesthetics or performance.

Non-limiting examples of platelet particles which are suitable for use in compositions of the present invention include various natural and synthetic silicate materials including talc, mica, sericite, titanated micas, magnesium aluminum silicates, aluminum silicate, calcium silicate, clays, bentonite, hectorite, montmorillonite, particulate sulfur, and mixtures thereof. Other non-limiting examples of platelet materials include boron nitride, and platelet titanium dioxides. Platelet particles of the present invention can have surface charges or their surface can be modified with organic or inorganic materials such as surfactants, polymers, and inorganic materials.

Non-limiting examples of commercially available platelet particles include Laponite XLS, Laponite SCPX-2549, Claytone SO and Gelwhite H NF available from Southern Clay Products Inc.; Bentone 38, Bentone 27, and Bentone 34 available from Rheox, Inc.; Flamenco Ultra Silk 2500, Flamenco Satin Pearl 3500 and Timica Silkwhite 110W available from Engelhard Corp; magnesium aluminum silicates sold by R.T. Vanderbilt Company, Inc., under the trade name Veegum; and Ultra Talc 2000, 3000, and 5000 available from Ultra Chemical.

In one embodiment of the present invention, the platelet particles are titanium dioxide/mica platelet particles. Such titanium dioxide/mica platelet particles are available as Flamenco Velvet Pearl from Engelhard Corp.

b. Spherical Particles

Spherical particles of the present invention are particles having a physical shape comprising a set of points in a metric space whose distance from a fixed point is approximately constant. Here, the meaning of “approximately” is that the fixed points are within a distance of ±15%. The spherical shape can be evaluated through optical or electron microscope evaluation. Spherical particles of the present invention may be hollow or solid in structure. Preferably, the spherical particles have either a non-uniform surface texture or a high porosity, or both. As used herein, “high porosity” refers to particles having a porosity which is equivalent to a pore volume equal to or greater than about 0.1 ml/g, preferably equal to or greater than about 1.0 ml/g.

Suitable spherical particles can be inorganic or organic, synthetic or natural in composition. Non-limiting examples of inorganic spherical particles include spherical silica particles available in various particle sizes and porosities including MSS-500/H, MSS-500/3H, MSS-500, and MSS-500/3, available from Kobo Products Inc.; and those available from Sunjin Chemical Co. under the trade name Sunsil including Sunsil 20, 20H, 50, 50H, 130, and 130H. Other non-limiting examples of spherical inorganic particles useful in the present invention include various silicates including magnesium silicate such as those available from 3M under the trade name CM-111 Cosmetic Microspheres, and glass spheres such as those available from Nippon Paint Corp. under the trade name PrizmaLite Glass Spheres.

The surface of the particle may be charged through a static development or with the attachment of various ionic groups directly or linked via short, long or branched alkyl groups. The surface charge can be anionic, cationic, zwitterionic or amphoteric in nature.

Preferred spherical particles include spherical silicas, polyethylenes, and polyamides.

c. Irregularly Shaped Particles

The irregularly shaped particles of the present invention are non-spherical and non-platelet particles which have an aspherical, oval, elliptical, or any other non-uniform shape and a non-uniform surface texture. Preferred irregularly shaped particles tend to have an oval, an ellipsoid, or any other shape in which the ratio of the largest dimension to the smallest dimension (defined as the “aspect ratio”) is less than about 10. Irregularly shaped particles are typically obtained through precipitation, grinding, or pulverizing, or are comprised of fused or aggregated primary particles to yield particles with non-uniform shape or surface texture.

Irregularly shaped particles suitable for use in compositions of the present invention can be inorganic or organic, synthetic or semi-synthetic in composition. Synthetic particles can be made of either cross-linked or non cross-linked polymers. Hybrid particles and particle complexes are also useful. The irregularly shaped particles can be of various shapes and densities. Suitable irregularly shaped particles include those which are generally known for use in hair care and other personal care compositions, such as those that are listed in the C.T.F.A. Cosmetic Ingredient Handbook, Sixth Ed., Cosmetic and Fragrance Assn., Inc., Washington D.C. (1995).

Non-limiting examples of irregularly shaped particles which are suitable for use in compositions of the present invention include fumed silica, polymethylmethacrylate, micronized teflon, boron nitride, barium sulfate, acrylate polymers, aluminum silicate, aluminum starch octenylsuccinate, calcium silicate, cellulose, chalk, corn starch, diatomaceous earth, Fuller's earth, glyceryl starch, hydrated silica, magnesium carbonate, magnesium hydroxide, magnesium oxide, magnesium trisilicate, maltodextrin, microcrystaline cellulose, rice starch, silica, titanium dioxide, zinc laurate, zinc myristate, zinc neodecanoate, zinc rosinate, zinc stearate, polyethylene, alumina, attapulgite, calcium carbonate, calcium silicate, dextran, polyamide (Nylon™), silica silylate, silk powder, soy flour, tin oxide, titanium hydroxide, trimagnesium phosphate, walnut shell powder, and mixtures thereof. The above mentioned irregularly shaped particles may be surface treated with lecithin, amino acids, mineral oil, silicone oil, or various other agents either alone or in combination, which coat the particle surface and render the particle hydrophobic in nature.

In one embodiment of the invention, the irregularly shaped particles are organic synthetic resin particles. Non-limiting examples of such organic synthetic resin particles include silicone resin particles available from GE Silicones under the trade names Tospearl 240 and SR1000.

In other embodiments of the invention, the irregularly shaped particles are various silica particles such as colloidal silicas, fumed silicas, precipitated silicas, and silica gels.

Non-limiting examples of such colloidal silicas include those available from Nissan Chemical America Corporation under the trade names Snowtex C, Snowtex O, Snowtex 50, Snowtex OL, Snowtex ZL; and from W.R. Grace & Co., under the trade name Ludox.

Non-limiting examples of such fumed silicas include hydrophillic and hydrophobic forms available as Aerosil 130, Aerosil 200, Aerosil 300, Aerosil R972 and Aerosil R812 from Degussa Corp.; and those available from Cabot Corp. under the trade name Cab-O-Sil, including Cab-O-Sil M-5, HS-5, TS-530, TS-610, and TS-720.

Non-limiting examples of such precipitated silicas include those available in both hydrophillic and hydrophobic versions from Degussa Corp. under the trade name Sipernat, including Sipernat 350, 360, 22LS, 22S, 320, 50S, D10, D11, D17, and C630; those sold by W. R. Grace & Co. under the trade name Syloid; those sold by the J.M. Huber Corp. under the trade name Zeothix and Zeodent; and those available from Rhodia under the trade name Tixosil.

Other non-limiting examples of useful inorganic irregularly shaped particles include various metallic oxides including titanium dioxide such as P25 available from Degussa; Tronox CR-840 available from Kerr McGee Chemical Corp.; MT-500B and MT-100T available from Tayca Corp.; aluminum oxide such as Aluminum Oxide C available from Degussa Corp.; and AC720, AC 712, and AC740 from AluChem Inc. Other suitable inorganic irregularly shaped particles include silicate glass particles such as Glamur Glo Glass Chips available from Nippon Paint Corp.

Preferred irregularly shaped particles include hydrophillic and hydrophobically modified precipitated silicas and aluminas.

D. Cosmetically Acceptable Medium

The compositions of the present invention comprise a cosmetically acceptable medium. The cosmetically acceptable medium is present in an amount from about 20% to about 95% by weight of the composition. The level and species of the medium are selected according to the compatibility with other components and other desired characteristic of the product. A cosmetically acceptable medium may be selected such that the composition of the present invention may be in the form of, for example, a pourable liquid (under ambient conditions), a gel, a paste, a dried powder, or a dried film.

Cosmetically acceptable mediums useful in the present invention include water and water solutions of lower alkyl alcohols. Lower alkyl alcohols useful herein are monohydric alcohols having 1 to 6 carbons, more preferably ethanol and isopropanol.

The pH of the present composition, measured neat, is preferably from about 3 to about 9, more preferably from about 4 to about 8. Buffers and other pH-adjusting agents can be included to achieve the desirable pH.

E. Additional Components

The compositions of the present invention may further comprise one or more optional components known for use in hair care or personal care products, provided that the optional components are physically and chemically compatible with the essential components described herein, or do not otherwise unduly impair product stability, aesthetics or performance. Individual concentrations of such optional components may range from about 0.001% to about 10%.

Non-limiting examples of optional components for use in the composition include cationic polymers, particles, conditioning agents (e.g., silicones, hydrocarbon oils, fatty esters), anti-dandruff agents, suspending agents, paraffinic hydrocarbons, propellants, viscosity modifiers, dyes, non-volatile solvents or diluents (water-soluble and water-insoluble), pearlescent aids, foam boosters, additional surfactants or nonionic cosurfactants, pediculocides, pH adjusting agents, perfumes, preservatives, chelants, proteins, skin active agents, sunscreens, UV absorbers, and vitamins.

1. Cationic Polymers

The compositions of the present invention may contain a cationic polymer to aid in deposition of the fibers and enhance conditioning performance. Suitable cationic polymers have a cationic charge density from about 1.2 meq/g to about 7.0 meq/g, preferably from about 1.5 meq/g to about 3.0 meq/g, more preferably from about 1.7 meq/g to about 2.5 meq/g, at the pH of intended use of the shampoo composition, which pH will generally range from about pH 3 to about pH 9, preferably from about pH 4 to about pH 8. The pH of the compositions of the present invention are measured neat. The average molecular weight of such suitable cationic polymers is between about 10,000 and about 10 million, preferably between about 50,000 and about 5 million, more preferably between about 100,000 and about 3 million.

Such cationic polymers may be present in the composition from about 0.01% to about 3%, preferably from about 0.05% to about 2.0%, more preferably from about 0.1% to about 1.0%, by weight of the composition.

Suitable cationic polymers for use in the compositions of the present invention contain cationic nitrogen-containing moieties such as quaternary ammonium or cationic protonated amino moieties. The cationic protonated amines can be primary, secondary, or tertiary amines (preferably secondary or tertiary), depending upon the particular species and the selected pH of the composition. Any anionic counterions can be used in association with the cationic polymers so long as the polymers remain soluble in water, in the composition, or in a coacervate phase of the composition, and so long as the counterions are physically and chemically compatible with the essential components of the composition or do not otherwise unduly impair product performance, stability or aesthetics. Non-limiting examples of such counterions include halides (e.g., chloride, fluoride, bromide, iodide), sulfate and methylsulfate.

Non-limiting examples of suitable cationic polymers include copolymers of vinyl monomers having cationic protonated amine or quaternary ammonium functionalities with water soluble spacer monomers such as acrylamide, methacrylamide, alkyl and dialkyl acrylamides, alkyl and dialkyl methacrylamides, alkyl acrylate, alkyl methacrylate, vinyl caprolactone or vinyl pyrrolidone.

Suitable cationic protonated amino and quaternary ammonium monomers, for inclusion in the cationic polymers of the composition herein, include vinyl compounds substituted with dialkylaminoalkyl acrylate, dialkylaminoalkyl methacrylate, monoalkylaminoalkyl acrylate, monoalkylaminoalkyl methacrylate, trialkyl methacryloxyalkyl ammonium salt, trialkyl acryloxyalkyl ammonium salt, diallyl quaternary ammonium salts, and vinyl quaternary ammonium monomers having cyclic cationic nitrogen-containing rings such as pyridinium, imidazolium, and quaternized pyrrolidone, e.g., alkyl vinyl imidazolium, alkyl vinyl pyridinium, alkyl vinyl pyrrolidone salts.

Other suitable cationic polymers for use in the compositions include copolymers of 1-vinyl-2-pyrrolidone and 1-vinyl-3-methylimidazolium salt (e.g., chloride salt) (Polyquaternium-16); copolymers of 1-vinyl-2-pyrrolidone and dimethylaminoethyl methacrylate (Polyquaternium-11); cationic diallyl quaternary ammonium-containing polymers, including, for example, dimethyldiallylammonium chloride homopolymer, copolymers of acrylamide and dimethyldiallylammonium chloride (Polyquaternium 6 and Polyquaternium 7, respectively); amphoteric copolymers of acrylic acid including copolymers of acrylic acid and dimethyldiallylammonium chloride (Polyquaternium 22), terpolymers of acrylic acid with dimethyldiallylammonium chloride and acrylamide (Polyquaternium 39), and terpolymers of acrylic acid with methacrylamidopropyl trimethylammonium chloride and methylacrylate (Polyquaternium 47). Preferred cationic substituted monomers are the cationic substituted dialkylaminoalkyl acrylamides, dialkylaminoalkyl methacrylamides, and combinations thereof.

Other suitable cationic polymers include those which conform to the formula: 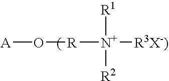
wherein A is an anhydroglucose residual group, such as a starch or cellulose anhydroglucose residual; R is an alkylene oxyalkylene, polyoxyalkylene, or hydroxyalkylene group, or combination thereof; R1, R2, and R3 independently are alkyl, aryl, alkylaryl, arylalkyl, alkoxyalkyl, or alkoxyaryl groups, each group containing up to about 18 carbon atoms, and the total number of carbon atoms for each cationic moiety (i.e., the sum of carbon atoms in R1, R2 and R3) preferably being about 20 or less; and X is an anionic counterion as described in hereinbefore.

Preferred cationic cellulose polymers are salts of hydroxyethyl cellulose reacted with trimethyl ammonium substituted epoxide, referred to in the industry (CTFA) as Polyquaternium 10 and available from Amerchol Corp. (Edison, N.J., USA) in their Polymer LR, JR, and KG series of polymers, such as Polymer KG30M having an average charge density of 1.9 meq/g and a molecular weight of 1.5-2.0 million. Other suitable types of cationic cellulose include the polymeric quaternary ammonium salts of hydroxyethyl cellulose reacted with lauryl dimethyl ammonium-substituted epoxide referred to in the industry (CTFA) as Polyquaternium 24. These materials are available from Amerchol Corp. under the tradename Polymer LM-200.

Other suitable cationic polymers include cationic guar gum derivatives, such as guar hydroxypropyltrimonium chloride, specific examples of which include the Jaguar series commercially avaialable from Rhone-Poulenc Incorporated and the N-Hance series commercially available from Aqualon Division of Hercules, Inc.

When used, the cationic polymers herein are either soluble in the composition or are soluble in a complex coacervate phase in the composition formed by the cationic polymer and the anionic, amphoteric and/or zwitterionic detersive surfactant component described hereinbefore. Complex coacervates of the cationic polymer can also be formed with other charged materials in the composition.

Techniques for analysis of formation of complex coacervates are known in the art. For example, microscopic analyses of the compositions, at any chosen stage of dilution, can be utilized to identify whether a coacervate phase has formed. Such coacervate phase will be identifiable as an additional emulsified phase in the composition. The use of dyes can aid in distinguishing the coacervate phase from other insoluble phases dispersed in the composition.

2. Conditioning Agents

Conditioning agents include any material which is used to give a particular conditioning benefit to hair and/or skin. In hair treatment compositions, suitable conditioning agents are those which deliver one or more benefits relating to shine, softness, combability, antistatic properties, wet-handling, damage, manageability, body, and greasiness. The conditioning agents useful in the compositions of the present invention typically comprise a water-insoluble, water-dispersible, non-volatile, liquid that forms emulsified, liquid particles. Suitable conditioning agents for use in the composition are those conditioning agents characterized generally as silicones (e.g., silicone oils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein. Such conditioning agents should be physically and chemically compatible with the essential components of the composition, and should not otherwise unduly impair product stability, aesthetics or performance.

The concentration of the conditioning agent in the composition should be sufficient to provide the desired conditioning benefits, and as will be apparent to one of ordinary skill in the art. Such concentration can vary with the conditioning agent, the conditioning performance desired, the average size of the conditioning agent particles, the type and concentration of other components, and other like factors.

a. Silicone Conditioning Agents

The conditioning agent of the compositions of the present invention is preferably a water-insoluble silicone conditioning agent. The silicone conditioning agent may comprise volatile silicone, non-volatile silicone, or combinations thereof. Preferred are non-volatile silicone conditioning agents. The silicone conditioning agent particles may comprise a silicone fluid and may also comprise other ingredients, such as a silicone resin to improve silicone fluid deposition efficiency or enhance glossiness of the hair.

The silicone conditioning agent may be present from about 0.01% to about 10%, preferably from about 0.1% to about 5%, more preferably from about 0.2% to about 3%, by weight of the composition. Non-limiting examples of suitable silicone conditioning agents, and optional suspending agents for the silicone, are described in U.S. Reissue Pat. No. 34,584, U.S. Pat. No. 5,104,646, and U.S. Pat. No. 5,106,609. The silicone conditioning agents for use in the compositions of the present invention preferably have a viscosity, as measured at 25° C., from about 20 to about 2,000,000 centistokes (“csk”), more preferably from about 1,000 to about 1,800,000 csk, even more preferably from about 50,000 to about 1,500,000 csk, more preferably from about 100,000 to about 1,500,000 csk.

In an opaque composition embodiment of the present invention, the personal care composition comprises a non-volatile silicone oil having a particle size as measured in the personal care composition from about 1 μm to about 50 μm. In an embodiment of the present invention for small particle application to the hair, the personal care composition comprises a non-volatile silicone oil having a particle size as measured in the personal care composition from about 100 nm to about 1 μm. A substantially clear composition embodiment of the present invention comprises a non-volatile silicone oil having a particle size as measured in the personal care composition of less than about 100 nm.

Non-volatile silicone oils suitable for use in compositions of the present invention may be selected from organo-modified silicones and fluoro-modified silicones. In one embodiment of the present invention, the non-volatile silicone oil is an organo-modified silicone which comprises an organo group selected from the group consisting of alkyl groups, alkenyl groups, hydroxyl groups, amine groups, quaternary groups, carboxyl groups, fatty acid groups, ether groups, ester groups, mercapto groups, sulfate groups, sulfonate groups, phosphate groups, propylene oxide groups, and ethylene oxide groups.

Background material on silicones including sections discussing silicone fluids, gums, and resins, as well as manufacture of silicones, are found in Encyclopedia of Polymer Science and Engineering, vol. 15, 2d ed., pp 204-308, John Wiley & Sons, Inc. (1989).

b. Organic Conditioning Oils

The compositions of the present invention may also comprise at least one organic conditioning oil as the conditioning agent, either alone or in combination with other conditioning agents, such as the silicones described above. Such organic conditioning oils are present from about 0.05% to about 3%, preferably from about 0.08% to about 1.5%, more preferably from about 0.1% to about 1%, by weight of the composition.

i. Hydrocarbon Oils

Suitable organic conditioning oils for use as conditioning agents in the compositions of the present invention include, but are not limited to, hydrocarbon oils having at least about 10 carbon atoms, such as cyclic hydrocarbons, straight chain aliphatic hydrocarbons (saturated or unsaturated), and branched chain aliphatic hydrocarbons (saturated or unsaturated), including polymers and mixtures thereof. Straight chain hydrocarbon oils preferably are from about C₁₂ to about C₁₉. Branched chain hydrocarbon oils, including hydrocarbon polymers, typically will contain more than 19 carbon atoms.

Specific non-limiting examples of these hydrocarbon oils include paraffin oil, mineral oil, saturated and unsaturated dodecane, saturated and unsaturated tridecane, saturated and unsaturated tetradecane, saturated and unsaturated pentadecane, saturated and unsaturated hexadecane, polybutene, polydecene, and mixtures thereof. Branched-chain isomers of these compounds, as well as of higher chain length hydrocarbons, can also be used, examples of which include highly branched, saturated or unsaturated, alkanes such as the permethyl-substituted isomers, e.g., the permethyl-substituted isomers of hexadecane and eicosane, such as 2,2,4,4,6,6,8,8-dimethyl-10-methylundecane and 2,2,4,4,6,6-dimethyl-8-methylnonane, available from Permethyl Corporation. Hydrocarbon polymers such as polybutene and polydecene. A preferred hydrocarbon polymer is polybutene, such as the copolymer of isobutylene and butene. A commercially available material of this type is L-14 polybutene from Amoco Chemical Corporation.

ii. Polyolefins

Organic conditioning oils for use in the compositions of the present invention can also include liquid polyolefins, more preferably liquid poly-α-olefins, more preferably hydrogenated liquid poly-α-olefins. Polyolefins for use herein are prepared by polymerization of C₄ to about C₁₄ olefenic monomers, preferably from about C₆ to about C₁₂.

Non-limiting examples of olefenic monomers for use in preparing the polyolefin liquids herein include ethylene, propylene, 1-butene, 1-pentene, 1-hexene, 1-octene, 1-decene, 1-dodecene, 1-tetradecene, branched chain isomers such as 4-methyl-1-pentene, and mixtures thereof. Also suitable for preparing the polyolefin liquids are olefin-containing refinery feedstocks or effluents.

iii. Fatty Esters

Other suitable organic conditioning oils for use as the conditioning agent in the compositions of the present invention include fatty esters having at least 10 carbon atoms. These fatty esters include esters with hydrocarbyl chains derived from fatty acids or alcohols. The hydrocarbyl radicals of the fatty esters hereof may include or have covalently bonded thereto other compatible functionalities, such as amides and alkoxy moieties (e.g., ethoxy or ether linkages, etc.).

Specific examples of preferred fatty esters include, but are not limited to, iso-propyl isostearate, hexyl laurate, isohexyl laurate, isohexyl palmitate, isopropyl palmitate, decyl oleate, isodecyl oleate, hexadecyl stearate, decyl stearate, isopropyl isostearate, dihexyldecyl adipate, lauryl lactate, myristyl lactate, cetyl lactate, oleyl stearate, oleyl oleate, oleyl myristate, lauryl acetate, cetyl propionate, and oleyl adipate.

Other fatty esters suitable for use in the compositions of the present invention are those known as polyhydric alcohol esters. Such polyhydric alcohol esters include alkylene glycol esters.

Still other fatty esters suitable for use in the compositions of the present invention are glycerides, including, but not limited to, mono-, di-, and tri-glycerides, preferably di- and tri-glycerides, more preferably triglycerides. A variety of these types of materials can be obtained from vegetable and animal fats and oils, such as castor oil, safflower oil, cottonseed oil, corn oil, olive oil, cod liver oil, almond oil, avocado oil, palm oil, sesame oil, lanolin and soybean oil. Synthetic oils include, but are not limited to, triolein and tristearin glyceryl dilaurate.

c. Other Conditioning Agents

i. Quaternary Ammonium Compounds

Suitable quaternary ammonium compounds for use as conditioning agents in the personal care compositions of the present invention include, but are not limited to, hydrophilic quaternary ammonium compounds with a long chain substituent having a carbonyl moiety, like an amide moiety, or a phosphate ester moiety or a similar hydrophilic moiety.

Examples of useful hydrophilic quaternary ammonium compounds include, but are not limited to, compounds designated in the CTFA Cosmetic Dictionary as ricinoleamidopropyl trimonium chloride, ricinoleamido trimonium ethylsulfate, hydroxy stearamidopropyl trimoniummethylsulfate and hydroxy stearamidopropyl trimonium chloride, or combinations thereof.

Examples of other useful quaternary ammonium surfactants include, but are not limited to, Quaternium-33, Quaternium-43, isostearamidopropyl ethyldimonium ethosulfate, Quaternium-22 and Quaternium-26, or combinations thereof, as designated in the CTFA Dictionary.

Other hydrophilic quaternary ammonium compounds useful in a composition of the present invention include, but are not limited to, Quaternium-16, Quaternium-27, Quaternium-30, Quaternium-52, Quaternium-53, Quaternium-56, Quaternium-60, Quaternium-61, Quaternium-62, Quaternium-63, Quaternium-71, and combinations thereof.

ii. Polyalkylene Glycols

Additional compounds useful herein as conditioning agents include polyethylene glycols and polypropylene glycols having a molecular weight of up to about 2,000,000 such as those with CTFA names PEG-200, PEG-400, PEG-600, PEG-1000, PEG-2M, PEG-7M, PEG-14M, PEG-45M, and mixtures thereof.

3. Anti-Dandruff Agents

The compositions of the present invention may also contain an anti-dandruff active. Suitable non-limiting examples of anti-dandruff actives include pyridinethione salts, azoles, selenium sulfide, particulate sulfur, and mixtures thereof. Preferred are pyridinethione salts. Such anti-dandruff particulate should be physically and chemically compatible with the essential components of the composition, and should not otherwise unduly impair product stability, aesthetics or performance.

The compositions of the present invention may further include one or more anti-fungal or anti-microbial actives in addition to the metal pyrithione salt actives. Suitable anti-microbial actives include coal tar, sulfur, whitfield's ointment, castellani's paint, aluminum chloride, gentian violet, octopirox (piroctone olamine), ciclopirox olamine, undecylenic acid and it's metal salts, potassium permanganate, selenium sulfide, sodium thiosulfate, keratolytic agents such as salicylic acid, propylene glycol, oil of bitter orange, urea preparations, griseofulvin, 8-Hydroxyquinoline ciloquinol, thiobendazole, thiocarbamates, haloprogin, polyenes, hydroxypyridone, morpholine, benzylamine, allylamines (such as terbinafine), tea tree oil, extracts of melaleuca, charcoal, clove leaf oil, coriander, palmarosa, berberine, thyme red, cinnamon oil, cinnamic aldehyde, citronellic acid, hinokitol, ichthyol pale, Sensiva SC-50, Elestab HP-100, azelaic acid, lyticase, iodopropynyl butylcarbamate (IPBC), isothiazalinones such as octyl isothiazalinone and azoles, and combinations thereof. Azole anti-microbials include imidazoles such as benzimidazole, benzothiazole, bifonazole, butaconazole nitrate, climbazole, clotrimazole, croconazole, eberconazole, econazole, elubiol, fenticonazole, fluconazole, flutimazole, isoconazole, ketoconazole, lanoconazole, metronidazole, miconazole, neticonazole, omoconazole, oxiconazole nitrate, sertaconazole, sulconazole nitrate, tioconazole, thiazole, and triazoles such as terconazole and itraconazole, and combinations thereof.

When present in the composition, the anti-dandruff active is included in an amount from about 0.01% to about 5%, preferably from about 0.1% to about 3%, and more preferably from about 0.3% to about 2%, by weight of the composition.

4. Suspending Agents

The compositions of the present invention may further comprise a suspending agent at concentrations effective for suspending water-insoluble material in dispersed form in the compositions or for modifying the viscosity of the composition. Such concentrations generally range from about 0.1% to about 10%, preferably from about 0.3% to about 5.0%, by weight of the composition, of suspending agent.

Suspending agents useful herein include anionic polymers and nonionic polymers. Useful herein are vinyl polymers such as cross linked acrylic acid polymers with the CTFA name Carbomer, cellulose derivatives and modified cellulose polymers such as methyl cellulose, ethyl cellulose, hydroxyethyl cellulose, hydroxypropyl methyl cellulose, nitro cellulose, sodium cellulose sulfate, sodium carboxymethyl cellulose, crystalline cellulose, cellulose powder, polyvinylpyrrolidone, polyvinyl alcohol, guar gum, hydroxypropyl guar gum, xanthan gum, arabia gum, tragacanth, galactan, carob gum, guar gum, karaya gum, carragheenin, pectin, agar, quince seed (Cydonia oblonga Mill), starch (rice, corn, potato, wheat), algae colloids (algae extract), microbiological polymers such as dextran, succinoglucan, pulleran, starch-based polymers such as carboxymethyl starch, methylhydroxypropyl starch, alginic acid-based polymers such as sodium alginate, alginic acid propylene glycol esters, acrylate polymers such as sodium polyacrylate, polyethylacrylate, polyacrylamide, polyethyleneimine, and inorganic water soluble material such as bentonite, aluminum magnesium silicate, laponite, hectonite, and anhydrous silicic acid.

Other optional suspending agents include crystalline suspending agents which can be categorized as acyl derivatives, long chain amine oxides, and mixtures thereof. These suspending agents include ethylene glycol esters of fatty acids preferably having from about 16 to about 22 carbon atoms. Other suitable suspending agents include alkanol amides of fatty acids, preferably having from about 16 to about 22 carbon atoms, more preferably about 16 to about 18 carbon atoms. Other long chain acyl derivatives include long chain esters of long chain fatty acids, long chain esters of long chain alkanol amides, and glyceryl esters.

Examples of suitable long chain amine oxides for use as suspending agents include alkyl dimethyl amine oxides, e.g., stearyl dimethyl amine oxide.

Other suitable suspending agents include primary amines having a fatty alkyl moiety having at least about 16 carbon atoms, and secondary amines having two fatty alkyl moieties each having at least about 12 carbon atoms. Still other suitable suspending agents include di(hydrogenated tallow)phthalic acid amide, and crosslinked maleic anhydride-methyl vinyl ether copolymer.

5. Paraffinic Hydrocarbons

The compositions of the present invention may contain one or more paraffinic hydrocarbons. Paraffinic hydrocarbons suitable for use in compositions of the present invention include those materials which are known for use in hair care or other personal care compositions, such as those having a vapor pressure at 1 atm of equal to or greater than about 21° C. (about 70° F.). Non-limiting examples include pentane and isopentane.

6. Propellants

The composition of the present invention also may contain one or more propellants. Propellants suitable for use in compositions of the present invention include those materials which are known for use in hair care or other personal care compositions, such as liquefied gas propellants and compressed gas propellants. Suitable propellants have a vapor pressure at 1 atm of less than about 21° C. (about 70° F.). Non-limiting examples of suitable propellants are alkanes, isoalkanes, haloalkanes, dimethyl ether, nitrogen, nitrous oxide, carbon dioxide, and mixtures thereof.

7. Other Optional Components

The compositions of the present invention may contain fragrance.

The compositions of the present invention may also contain water-soluble and water-insoluble vitamins such as vitamins B1, B2, B6, B12, C, pantothenic acid, pantothenyl ethyl ether, panthenol, biotin, and their derivatives, and vitamins A, D, E, and their derivatives. The compositions of the present invention may also contain water-soluble and water-insoluble amino acids such as asparagine, alanine, indole, glutamic acid, and their salts, and tyrosine, tryptamine, lysine, histadine, and their salts.

The compositions of the present invention may also contain chelating agents.

F. Method of Making

The compositions of the present invention, in general, may be made by mixing the ingredients together at either room temperature or at elevated temperature, e.g., about 72° C. Heat only needs to be used if solid ingredients are in the composition. The ingredients are mixed at the batch processing temperature. Additional ingredients, including electrolytes, polymers, and particles, may be added to the product at room temperature.

G. Method of Use

The personal cleansing compositions of the present invention are used in a conventional manner for providing both increased volume and superior styling and conditioning to hair. An effective amount of the composition for providing both increased volume and superior styling and conditioning to hair is applied to the hair, which has preferably been wetted with water, and then rinsed off. Such effective amounts generally range from about 1 g to about 50 g, preferably from about 1 g to about 20 g. Application to the hair typically includes working the composition through the hair such that most or all of the hair is contacted with the composition.

This method for providing both increased volume and superior styling and conditioning to hair comprises the steps of: (a) wetting the hair with water; (b) applying an effective amount of the personal cleansing composition to the hair; and (c) rinsing the applied areas of hair with water. These steps can be repeated as many times as desired to achieve the desired cleansing and conditioning benefit.

The personal care compositions of this invention may be used as liquids, solids, semi-solids, flakes, gels, placed in a pressurized container with a propellant added, or used in a pump spray form. The viscosity of the product may be selected to accommodate the form desired.

### Non-Limiting Examples

The compositions illustrated in the following Examples illustrate specific embodiments of the compositions of the present invention, but are not intended to be limiting thereof. Other modifications can be undertaken by the skilled artisan without departing from the spirit and scope of this invention. These exemplified embodiments of the composition of the present invention provide cleansing of hair and volumizing benefits with good wet conditioning and combing performance.

The compositions illustrated in the following Examples are prepared by conventional formulation and mixing methods, an example of which is set forth herein below. All exemplified amounts are listed as weight percents and exclude minor materials such as diluents, preservatives, color solutions, imagery ingredients, botanicals, and so forth, unless otherwise specified.

The compositions of the present invention may be prepared using conventional formulation and mixing techniques. Where melting or dissolution of solid surfactants or wax components is required these can be added to a premix of the surfactants, or some portion of the surfactants, mixed and heated to melt the solid components, e.g., about 72° C. This mixture can then optionally be processed through a high shear mill and cooled, and then the remaining components are mixed in. The compositions of the present invention, prior to the addition of materials such as gellants or propellants, typically have a viscosity from about 2,000 cps to about 20,000 cps. The viscosity of the composition can be adjusted by conventional techniques including addition of sodium chloride or ammonium xylenesulfonate as needed. The listed formulations, therefore, comprise the listed components and any minor materials associated with such components.

The following are representative of shampoo compositions of the invention:

| | Examples | | | | | | | | | | | | | | | | |
|---|---|---|---|---|---|---|---|---|---|---|---|---|---|---|---|---|---|
| Ingredient | 1 | 2 | 3 | 4 | 5 | 6 | 7 | 8 | 9 | 10 | 11 | 12 | 13 | 14 | 15 | 16 | 17 |
| Sodium Laureth-3 Sulfate | 10 | 14 | 14 | 14 | 10 | 10 | 10 | 10 | 10 | 10 | 10 | 10 | 8 | 8 | — | — | — |
| Sodium Lauryl Sulfate | 6 | 2 | 2 | 2 | 6 | 6 | 6 | 6 | 6 | 6 | 6 | 6 | 8 | 4 | — | — | — |
| Ammonium Laureth—3 Sulfate | — | — | — | — | — | — | — | — | — | — | — | — | — | — | 10 | 12.5 | 8 |
| Ammonium Lauryl Sulfate | — | — | — | — | — | — | — | — | — | — | — | — | — | — | 6 | 1.5 | 8 |
| Cocamidopropylbetaine | — | — | — | — | — | — | — | — | — | — | — | — | — | 4 | — | 2.7 | — |
| Polyquat 10 (1) | 0.25 | — | — | — | 0.25 | 0.15 | 0.25 | 0.5 | 0.25 | 0.25 | 0.25 | 0.25 | 0.25 | 0.5 | 0.25 | 0.5 | — |
| Polyquat 10 (2) | — | 0.25 | — | — | — | — | — | — | — | — | — | — | — | — | — | — | — |
| Polyquat 10 (3) | — | — | 0.25 | — | — | — | — | — | — | — | — | — | — | — | — | — | 0.75 |
| Polyquat 10 (4) | — | — | — | 0.5 | — | — | — | — | — | — | — | — | — | — | — | — | — |
| hydrocarbon wax (5) | 1 | 1 | 2 | 2 | — | 1.5 | — | 0.5 | — | — | — | 1 | 2 | 2 | 1 | 2 | 1 |
| oxidized polyethylene wax (6) | — | — | — | — | 1 | — | — | — | — | — | — | — | — | — | — | — | — |
| modified polyethylene wax (7) | — | — | — | — | — | — | 1 | — | — | — | — | — | — | — | — | — | — |
| modified polyethylene wax (8) | — | — | — | — | — | — | — | — | 1 | — | — | — | — | — | — | — | — |
| oxidized polyethylene wax (9) | — | — | — | — | — | — | — | — | — | 1 | — | — | — | — | — | — | — |
| polyethylene / | — | — | — | — | — | — | — | — | — | — | 0.5 | 0.25 | — | — | — | — | — |
| polytetrafluroethylene (10) | | | | | | | | | | | | | | | | | |
| dimethicone (11) | — | — | — | — | — | 1 | 0.5 | — | — | — | — | — | — | — | — | 0.25 | — |
| dimethicone (12) | — | — | — | 0.5 | — | — | — | — | 0.5 | — | — | — | — | — | — | — | — |
| fumed silica (13) | — | 0.2 | — | — | — | — | — | — | — | — | 0.25 | — | — | — | — | 0.5 | — |
| Zinc Pyrithione (14) | — | — | — | — | — | 0.5 | — | — | — | — | — | — | — | — | — | — | — |
| titanium dioxide/ mica Platelet (15) | — | — | 1 | — | — | — | — | — | 0.5 | — | — | — | — | 0.25 | — | — | — |
| hydrophobic precipitated silica (16) | — | — | — | 0.3 | — | — | 0.75 | — | — | — | — | — | — | — | — | — | — |
| precipitated silica (17) | 0.3 | — | — | — | 0.5 | — | — | — | — | 0.3 | — | 0.7 | 1 | 0.25 | — | — | 0.3 |
| polymethylsilsesquioxane (18) | — | — | — | — | — | — | — | 0.5 | — | — | — | — | — | — | 1 | — | — |
| high porosity spherical silica (19) | — | — | — | — | — | — | — | — | — | — | — | — | — | — | — | 0.25 | 1 |
| trihydroxystearin (20) | 0.5 | 0.25 | 0.25 | 0.15 | 0.25 | 0.1 | 0.25 | 0.5 | 0.15 | 0.25 | 0.25 | 0.3 | 0.3 | 0.1 | 0.5 | 0.5 | 0.25 |
| Cocamide MEA | 0.8 | 0.8 | 0.8 | 0.8 | 0.8 | 0.8 | 0.8 | 0.8 | 0 | 0.8 | 0.8 | 0.8 | 0.8 | 0 | 0.8 | 0.8 | 0 |
| Perfume Solution | 0.7 | 0.7 | 0.7 | 0.7 | 0.7 | 0.7 | 0.7 | 0.7 | 0.7 | 0.7 | 0.7 | 0.7 | 0.7 | 0.7 | 0.55 | 0.55 | 0.55 |
| Citric Acid | 0.23 | 0.23 | 0.23 | 0.23 | 0.23 | 0.23 | 0.23 | 0.23 | 0.23 | 0.23 | 0.23 | 0.23 | 0.23 | 0.23 | 0.04 | 0.04 | 0.04 |
| Sodium Benzoate | 0.25 | 0.25 | 0.25 | 0.25 | 0.25 | 0.25 | 0.25 | 0.25 | 0.25 | 0.25 | 0.25 | 0.25 | 0.25 | 0.25 | 0.25 | 0.25 | 0.25 |
| Sodium Chloride | 1.5 | 2 | 1 | 2 | 1.5 | 1.5 | 1.5 | 1.5 | 1.5 | 1.5 | 1.5 | 1.5 | 0.2 | 1.5 | 0.5 | 3.5 | 0 |
| Water and Minors (q.s. to 100%) | q.s. | q.s. | q.s. | q.s. | q.s. | q.s. | q.s. | q.s. | q.s. | q.s. | q.s. | q.s. | q.s. | q.s. | q.s. | q.s. | q.s. |

(1) Polymer KG30M available from Amerchol
(2) Polymer JP available from Amerchol
(3) Polymer KG-4M available from Amerchol
(4) Polymer JR-30M available form Amerchol
(5) Cendust 2051 available from Clariant
(6) Ceridust 3719 available from Clariant
(7) Ceridust 3251 available from Clariant
(8) Ceridust 9615A available from Clariant
(9) Micropoly 210 available from Micro Powders Inc.
(10) Microsilk 419 available from Micro Powders Inc.
(11) Viscasil 330M available from General Electric Silicones
(12) Emulsion of 70,000 csk polydimethylsiloxane with a particle size of approximately 30 nm available as DC1870 from Dow Coming
(13) Aerosil 200 available from Degussa Corp.
(14) 2.5 mm ZPT available from Arch/Olin.
(15) Flamenco Velvet Pearl available from Engelhard Corporation
(16) Sipemat D11 available from Degussa
(17) Sipemat 22L5 available from Degussa
(18) Tospearl 240 available from GE Silicones
(19) M55500/3H available from Kobo Products, Inc.
(20) Thixin R available from Rheox, Inc.

The following are representative of conditioner compositions of the invention:

| | Examples | | | | | | | |
|---|---|---|---|---|---|---|---|---|
| Ingredient | 18 | 19 | 20 | 21 | 23 | 24 | 25 | 26 |
| L-Glutamic Acid | 0.640 | 0.412 | — | — | 0.640 | 0.412 | — | — |
| Stearamidopropyldimethylamine | 2.000 | 1.600 | 1.000 | — | 2.000 | 1.600 | 1.000 | — |
| Behentrimonium Chloride | — | — | — | 3.380 | — | — | — | 3.380 |
| Quaterium- 18 | — | — | 0.750 | — | — | — | 0.750 | — |
| Cetyl Alcohol | 2.500 | 2.000 | 0.960 | 2.320 | 2.500 | 2.000 | 0.960 | 2.320 |
| Stearyl Alcohol | 4.500 | 3.600 | 0.640 | 4.180 | 4.500 | 3.600 | 0.640 | 4.180 |
| Cetearyl Alcohol | — | — | 0.500 | — | — | — | 0.500 | — |
| Polysorbate 60 | — | — | 0.500 | — | — | — | 0.500 | — |
| Glyceral Monostearate | — | — | 0.250 | — | — | — | 0.250 | — |
| Oleyl Alcohol | — | — | 0.250 | — | — | — | 0.250 | — |
| Hydroxyethylcellulose | — | — | 0.250 | — | — | — | 0.250 | — |
| Peg 2M (1) | — | — | 0.500 | — | — | — | 0.500 | — |
| Dimethicone (2) | — | 0.200 | — | — | — | 0.200 | — | — |
| Dimethicone (3) | 0.630 | — | 0.630 | 0.630 | 0.630 | — | 0.630 | 0.630 |
| Cyclopentasiloxane (3) | 3.570 | — | 3.570 | 3.570 | 3.570 | — | 3.570 | 3.570 |
| Benzyl Alcohol | 0.400 | 0.400 | 0.400 | 0.400 | 0.400 | 0.400 | 0.400 | 0.400 |
| Methyl Paraben | 0.200 | 0.200 | 0.200 | 0.200 | 0.200 | 0.200 | 0.200 | 0.200 |
| Propyl Paraben | 0.100 | 0.100 | 0.100 | 0.100 | 0.100 | 0.100 | 0.100 | 0.100 |
| Phenoxy Ethanol | 0.300 | 0.300 | 0.300 | 0.300 | 0.300 | 0.300 | 0.300 | 0.300 |
| Sodium Chloride | 0.010 | 0.010 | — | — | 0.010 | 0.010 | — | — |
| Citric Acid | 0.130 | 0.130 | 0.200 | — | 0.130 | 0.130 | 0.200 | — |
| Kathon | — | — | — | — | — | — | — | — |
| Perfume | 0.400 | 0.400 | 0.400 | 0.300 | 0.400 | 0.400 | 0.400 | 0.300 |
| Sodium Hydroxide | — | — | — | 0.014 | — | — | — | 0.014 |
| Isopropyl Alcohol | — | — | — | 0.507 | — | — | — | 0.507 |
| hydrocarbon wax (4) | 1.000 | 1.000 | — | — | 0.750 | 1.500 | — | — |
| oxidized polyethylene wax (5) | — | — | 1.000 | — | — | — | 2.000 | — |
| oxidized polyethylene wax (6) | — | — | — | 1.000 | — | — | — | 1.000 |
| fumed silica (7) | — | — | 0.300 | — | — | — | 0.750 | — |
| hydrophobic precipitated silica (8) | — | 0.300 | — | — | 0.150 | — | — | 0.050 |
| precipitated silica (9) | 0.300 | — | — | — | — | 0.750 | — | — |
| Water (q.s. to 100%) | q.s. | q.s. | q.s. | q.s. | q.s. | q.s. | q.s. | q.s. |

(1) Polyox WSR N-10 available from Amerchol Corp.
(2) 10,000 cps Dimethicone TSF451-1MA available from GE
(3) 15/85 Dimethicone/ Cyclomethicone Blend available from GE
(4) Ceridust 2051 available from Clariant
(5) Ceridust 3719 available from Clariant
(6) Micropoly 210 available from Micro Powders Inc.
(7) Aerosil 200 available from Degussa Corp.
(8) Sipemat D11 available from Degussa
(9) Sipernat 22LS available from Degussa

All documents cited herein are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is, therefore, intended to cover in the appended claims all such changes and modifications that are within the scope of this invention.

What is claimed is:

1. A personal cleansing composition comprising:
a) from about 5 wt. % to about 50 wt. % of a detersive surfactant,
b) from about 0.05 wt. % to about 20 wt. % of a first particle which is a wax particle having a melting point of at least about 90° C. and an average mean particle size as measured in said personal cleansing composition from about 0.15 μm to about 100 μm;
c) from about 0.05 wt. % to about 20 wt. % of a second particle which is selected from the group consisting of platelet particles, spherical particles, irregularly shaped particles, and mixtures thereof, said second particle having an average mean particle size as measured in said personal cleansing composition from about 0.15 μm to about 300 μm; and
d) at least about 20 wt. % of a cosmetically acceptable medium;
wherein said first particle and said second particle together form a load-sensitive deposit upon dilution of said personal cleansing composition with water.

2. A personal cleansing composition according to claim 1, wherein said load-sensitive deposit forms upon dilution of said personal cleansing composition with water at a ratio of water to personal cleansing composition of at least about 1:1.

3. A personal cleansing composition according to claim 1, wherein said first particle which is a wax particle is selected from the group consisting of polyethylenes, modified polyethylenes, oxidized polyethylenes, polytetrafluoroethylene modified polyethylenes, polypropylenes, synthetic hydrocarbons and aliphatic compounds synthesized using the Fischer-Tropsch process, hydrocarbon waxes, and mixtures thereof.

4. A personal cleansing composition according to claim 3, wherein said first particle which is a wax is a hydrocarbon wax having an average mean particle size from about 1 μm to about 30 μm.

5. A personal cleansing composition according to claim 1, wherein said second particle is selected from the group consisting of silica, precipitated silica, hydrated silica, aluminum silicate, magnesium silicate, titanium dioxide, mica, alumina, calcium carbonate, aluminum starch octenylsuccinate, cellulose, microcrystaline cellulose, silicone resins, polymethylmethacrylate, acrylate polymers, polyethylene, polypropylene, polytetrafluoroethylene, polyurethane, polyamide, epoxy resins, and mixtures thereof.

6. A personal cleansing composition according to claim 5, wherein said second particle has an average mean particle size from about 1 μm to about 40 μm.

7. A personal cleansing composition according to claim 1, wherein the ratio of first particles to second particles is equal to or greater than about 1:1.

8. A personal cleansing composition according to claim 1, further comprising a cationic polymer.

9. A personal cleansing composition according to claim 8, wherein said cationic polymer has a charge density from about 1.2 meq/g to about 7 meq/g and a molecular weight from about 10,000 to about 10,000,000.

10. A personal cleansing composition according to claim 9, wherein said cationic polymer has a charge density from about 1.5 meq/g to about 3.0 meq/g.

11. A personal cleansing composition according to claim 9, wherein said cationic polymer has a charge density from about 1.7 meq/g to about 2.5 meq/g.

12. A personal cleansing composition according to claim 8, wherein said cationic polymer is selected from the group consisting of cationic cellulose derivatives and cationic guar gum derivatives.

13. A personal cleansing composition according to claim 1, further comprising a conditioning agent.

14. A personal cleansing composition according to claim 13, wherein said conditioning agent is selected from the group consisting of silicone conditioning agents, hydrocarbon oils, polyolefins, fatty esters, and mixtures thereof.

15. A personal cleansing composition according to claim 1, further comprising one or more additional components selected from the group consisting of anti-dandruff agents, suspending agents, paraffinic hydrocarbons, and propellants.

16. A personal cleansing composition comprising:
a) from about 5 wt. % to about 50 wt. % of a detersive surfactant,
b) from about 0.05 wt. % to about 20 wt. % of a first particle which is a wax particle having a melting point of at least about 90° C. and an average mean particle size as measured in said personal cleansing composition from about 0.15 μm to about 100 μm;
c) from about 0.05 wt. % to about 20 wt. % of a second particle which is selected from the group consisting of platelet particles, irregularly shaped particles, and mixtures thereof, said second particle having an average mean particle size as measured in said personal cleansing composition from about 0.15 μm to about 300 μm;
d) from about 0.01 wt. % to about 3 wt. % of a cationic polymer; and
e) at least about 20 wt. % of a cosmetically acceptable medium;
wherein said first particle and said second particle together form a load-sensitive deposit upon dilution of said personal cleansing composition with water.

17. A method of providing both increased volume and superior styling and conditioning to hair, said method comprising the steps of:
a) applying to wet hair a composition comprising:
i) from about 5 wt. % to about 50 wt. % of a detersive surfactant;
ii) from about 0.05 wt. % to about 20 wt. % of a first particle which is a wax particle having a melting point of at least about 90° C. and an average mean particle size as measured in said composition from about 0.15 μm to about 100 μm;
iii) from about 0.05 wt. % to about 20 wt. % of a second particle which is selected from the group consisting of platelet particles, irregularly shaped particles, and mixtures thereof, said second particle having an average mean particle size as measured in said composition from about 0.15 μm to about 300 μm; and
iv) at least about 20 wt. % of a cosmetically acceptable medium;
wherein said first particle and said second particle together form a load-sensitive deposit upon dilution of said composition with water; and
b) rinsing said composition from said hair.
